(19) United States
(12) Patent Application Publication
(10) Pub. No.: US 2026/0340026 A1
(43) Pub. Date: Oct. 29, 2026

(54) SCALABLE OBJECT RECOGNITION SYSTEM

(71) Applicant: Beijing YoJaJa Software Technology Development Co., Ltd., Beijing (CN)

(72) Inventors: Shuai Lou, Beijing (CN); Kui Wang, Beijing (CN); Jun Sun, Beijing (CN); Mo Cheng, Beijing (CN)

(73) Assignee: Beijing YoJaJa Software Technology Development Co., Ltd., Beijing (CN)

(21) Appl. No.: 19/193,593

(22) Filed: Apr. 29, 2025

(51) Int. Cl. G06F 16/51; G06F 16/538; G06F 16/55; G06V 10/764

(52) U.S. Cl. CPC G06F 16/51; G06F 16/538; G06F 16/55; G06V 10/764

(57) ABSTRACT

In some embodiments, a method receives a plurality of images based on a search using a name for a first object. Object detection is performed to determine a collection of objects. The method performs object clustering on the collection of objects to generate a plurality of object clusters. A cluster in the plurality of object clusters is selected where the cluster includes one or more versions of the first object. The method encodes the one or more versions of the first object into one or more representations. The one or more representations are stored in a database to update the database. The database is used to recognize the first object in an input image.

### BACKGROUND

A system may use a dataset to recognize objects in an image by comparing the similarity between the objects in the dataset and an input image. The dataset may be static. However, a company may want the system to recognize new objects. However, the static dataset may not include enough objects to accurately recognize the new objects.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for detecting objects in an image according to some embodiments.

FIG. 2 depicts a more detailed example of a recognition system according to some embodiments.

FIG. 3 depicts a simplified flowchart of a method for generating representations of objects according to some embodiments.

FIG. 4 depicts an example of object samples according to some embodiments.

FIG. 5 depicts an example of clustering of the object samples if pre-processing is not performed according to some embodiments.

FIG. 6 depicts a simplified flowchart of a method for performing pre-processing according to some embodiments.

FIG. 7 depicts an example of selecting seed samples according to some embodiments.

FIG. 8 illustrates one example of a computing device according to some embodiments.

### DETAILED DESCRIPTION

Described herein are techniques for a content analysis system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system may use a dataset of object images for objects that should be recognized. Examples of objects include people, computers, inanimate characters, animals, buildings, furniture, electronics, logos, symbols, recipes, dishes, or food items. The system encodes the object images into representations (e.g., embeddings) that are stored in a database, such as a vector store. The representations may be associated with object information, such as an object name. Different data structures may be used, such as an index with representations as keys and the object name as their corresponding values. Then, the name can be retrieved using representation as the key. When searching for object information, an input image may be received. The system encodes the input image into an input representation. Then, the system determines a representation in the database that is considered to be similar to the input representation. The object information that is associated with the representation is then used to provide a response. For example, the response may be the object name, or other information, such as a description of the object.

The system efficiently scales the database with new representations to accurately recognize new objects that are not found in the current version of the dataset. The system may perform the scaling automatically with an efficient use of resources. For example, the system may receive a new object name of a target object and perform a search for the object name. The search may yield a collection of images. Because the search is run with the object name, the results may be relevant to the target object (e.g., includes the target object). The system may run an object detection algorithm on the images to determine a set of objects. The objects that are detected may be mostly of the target object, but there may be other objects. For example, if faces are being detected, multiple faces may be determined if there are multiple people in the image. The system runs a clustering algorithm on the set of objects to determined clusters of objects. The clustering may cluster objects based on a type of object. For example, similar types of objects are clustered together, such as a golden retriever dog, a bulldog, a type of car, a first specific person, a second specific person, etc. may be separately clustered. The objects in a cluster may include similar characteristics, such as characteristics within a threshold. The system then selects one of the clusters as including images of the target object corresponding to the object name. In some embodiments, the system selects the cluster with the largest number of objects. If the search yields objects that most likely are of the target object, then the largest cluster may be of the target object.

The system may improve the database. If all the objects from the search are added to the database, then the database may not be accurate. For example, some searches for an input object may yield objects that are not the input object because other objects were not filtered out from the search. Also, the database may not use resources efficiently because the other objects may use storage space. The use of clustering and selecting one cluster may use less storage space in the database.

Also, the system may improve the clustering process. For example, the existence of images of objects other than the target object may impact the clustering accuracy. The system may preprocess the set of images to improve the accuracy by removing some images that may not be associated with the target object. Also, the system determines a distance threshold that is used to perform the clustering. The preprocessing may improve resource usage by reducing the objects to be clustered, which requires less computational resources. Also, the clustering may be performed faster. Further, the entire process to add the target object to the dataset may be automated, improving the speed at which new objects can be added to the dataset. If a large language model was being used to recognize objects, then the large language model may have to be retrained to adjust parameters. That process may take more resources and time than the current system. The use of the database of representations may also allow for faster retrieval of an object name, such as compared to using a large language model, which includes more logic and parameters. The database of representations uses less logic to retrieve a representation and determine the object name.

### System

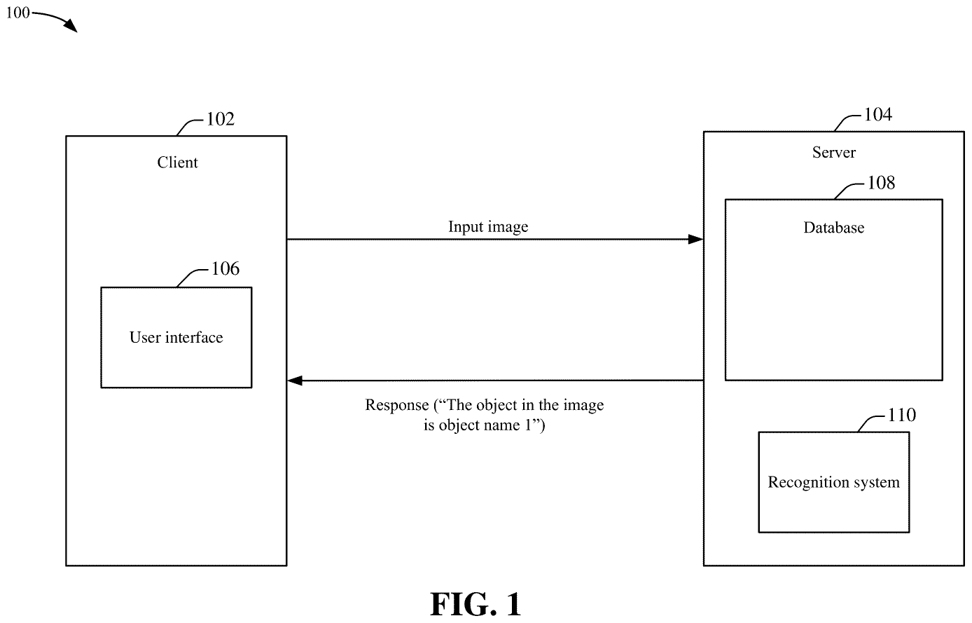

FIG. 1 depicts a simplified system 100 for detecting objects in an image according to some embodiments. System 100 includes a client 102 and a server 104. Although single instances of the client and the server are shown, multiple instances may be appreciated. For example, server 104 may be responding to multiple requests from different clients 102.

Client 102 may be a computing device, such as a smartphone, laptop computer, tablet device, living room device, or other types of devices. Client 102 includes a user interface 106 in which an entity (e.g., a user, program, etc.) may input a query. For example, the query may be an input image, which is the content that the entity wants to analyze. In some embodiments, the entity may want to recognize an object in the image, such as a performer, inanimate object, etc. For example, frames of a video that is being delivered by a content delivery system may be extracted and objects are recognized in the frames.

Database 108 may store representations of object images from a dataset. For example, a recognition system 110 encodes object images from a dataset into representations (e.g., embeddings) that are stored in database 108. Database 108 stores and manages vector-embedded data, which represents complex information, such as images, or other multimedia content, as dense representations in a high-dimensional space. The representations may be numerical representations of the image's semantic meaning. For example, an object might be represented as a vector of numbers, where each dimension corresponds to characteristics of the object. Database 108 enables efficient similarity searches, where the goal is to find the most similar representations to an input representation. The representations may be indexed to allow for efficient retrieval of similar representations.

Server 104 receives an input image. Recognition system 110 may process the input image to generate a response. A database 108 may include representations of objects, such as embeddings of objects. Recognition system 110 encodes the input image into an input representation. Then, recognition system 110 determines a representation in database 108 that is considered to be most similar to the input representation. Object information that is associated with the representation is then used to provide a response. For example, the response may be the object name, or other information, such as a description of the object. In some embodiments, the image is a query for an object name of an object in the input image. The response may be “The object in the image is object name 1”. Database 108 may be used in different services, such as the database can power recommendations, personalization for media platforms, or other searches. A system may receive a query, such as an image, from a user. Then, server system 102 may use the image to query database 108. Server system 102 may identify a representation in database 108 that corresponds to the image. Then, server system 102 prepares a response, such as using a label that is associated with the representation to generate a response. This response may be used to provide services, such as identification services, but also recommendation services for the object, personalization using the object, etc. Additionally, searches using labels may also be performed. Once receiving a label, server system 102 may return objects that are associated with the label, such as images that are associated with the label.

The following will now describe a more detailed example of recognition system 110.

### Recognition System

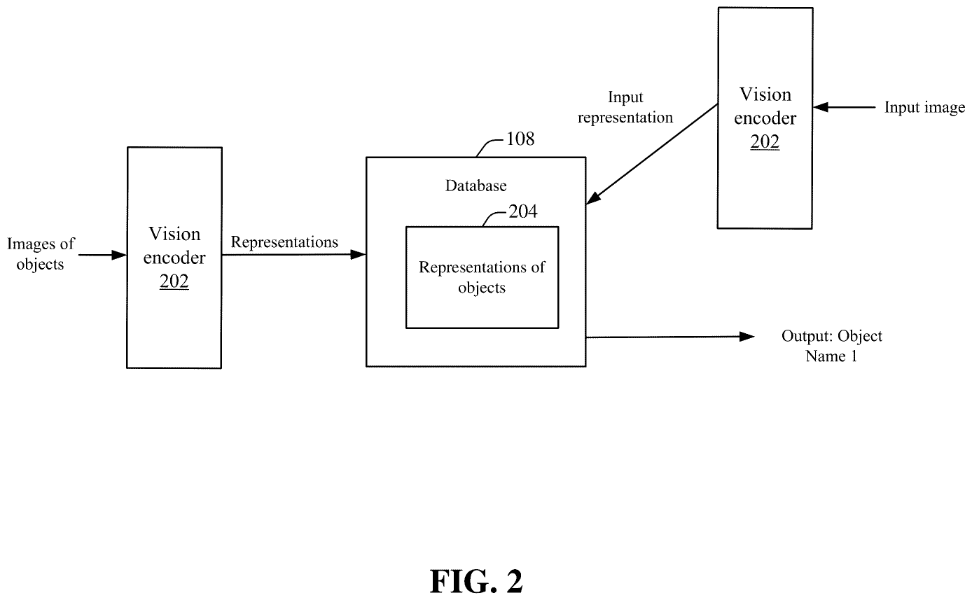

FIG. 2 depicts a more detailed example of recognition system 110 according to some embodiments. Recognition system 110 may operate in multiple stages, such as in a database update stage and in a processing stage. In the database update stage, recognition system 110 may populate database 108 with representations of objects 204. Also, in the processing stage, recognition system 110 may receive an input image and determine a response for the input image, such as outputting information that identifies the object.

In the population of database 108 with representations of objects 204, a vision encoder 202 of recognition system 110 receives object samples. The object samples may be images of different objects from a dataset. For example, the object samples may be detected individuals, inanimate objects, or other objects that a content delivery system wants to add to database 108. In some embodiments, the objects may be performers in media content, such as actors or actresses. For example, the images of frames from a video that is being offered for a delivery by the content delivery system may be used. Then, object samples of objects may be detected from the frames. In other embodiments, the object samples may include other objects, such as pictures of food, computers, etc. In some embodiments, the object samples that are received include an individual image of one object. For example, the image of an object may include facial data for a person.

Vision encoder 202 encodes the images of objects into representations of the object. Vision encoder 204 may include neural network components that process the object sample to extract meaningful features from the visual data. The features are encoded into the representation in a space. An example of the representation may be an array or a list of floating numbers. The length of the array could be from several hundreds to thousands. In some embodiments, an array may be array([0.4316784, 0.28901438, 0.96189958, . . . , 0.87746905, 0.73488661,0.34667482]).

Vision encoder 202 stores the representations in database 108. The representations may be indexed in database 108 to allow for efficient searching of the representations. The representations may be associated with information about respective objects. In some embodiments, information about the object may include the object name. In other embodiments, the representation may be associated with additional information about the object, such as a description of the object.

After populating database 108 with representations of objects 204, recognition system 110 may process queries. In some embodiments, recognition system 110 may receive an input image as the query. The input image may include an object that should be identified. In some embodiments, a user may input the image because the user may want to identify the object in the image, such as a performer from a frame of a video. For example, recognition system 110 may process a query to identify an object in an input image. Also, the input image may include multiple objects that can be identified.

Vision encoder 202 encodes the input image into a representation. Vision encoder 202 operates in the same way as when vision encoder 202 generated representations to store in database 108. Here, recognition system 110 may detect an input object sample from the input image. Then, vision encoder 202 outputs an input representation for the input object sample.

Recognition system 110 determines a representation of an object in database 108 that is considered most similar to the input representation. For example, recognition system 110 may perform a comparison of distances between the input representation and other representations in database 108. Recognition system 110 determines the representation of an object that is considered closest in distance to the input representation.

Once the representation in database 108 is determined, recognition system 110 may retrieve associated information for the representation, such as the name of the object. Other information may also be returned, such as a description of the object. Here, the output may be the “The object name is Object Name 1”, where Object Name 1 is the name of the most similar object to the input object in the input image.

The following will now describe the population of database 108 with representations of objects in more detail.

### Representation Generation

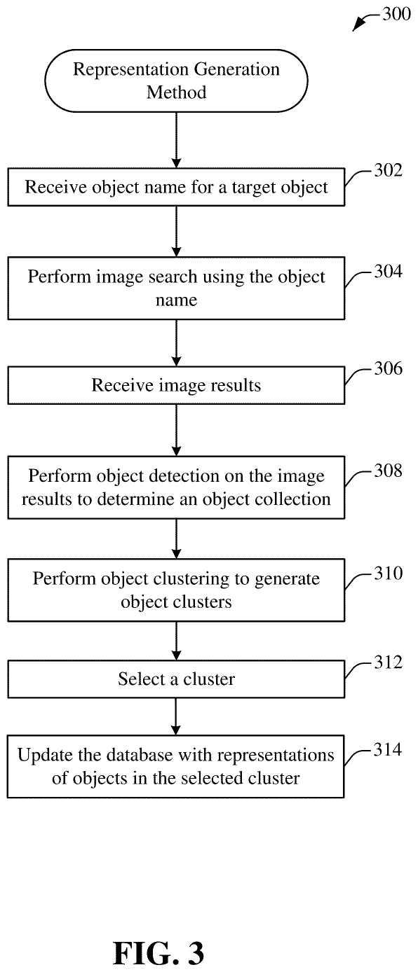

FIG. 3 depicts a simplified flowchart 300 of a method for generating representations of objects according to some embodiments. The process may be performed automatically whenever representations should be added to database 108. For example, the process may be performed periodically to add new performers that are detected in frames of videos. Also, the process may be performed dynamically when one performer is detected in a video.

At 302, recognition system 110 receives an object name for a target object. The object name may be determined from a target object that should be added to database 108. The object name may be the name of a person, such as the name of a performer in a video. In some embodiments, a video may be added to a content delivery system. Recognition system 110 may analyze metadata for the video to determine a list of performers in the video. Then, recognition system 110 determines which performer names are not in the index. In some embodiments, in a video streaming system, a content ingestion system receives content to upload to the system. Recognition system 110 may subscribe to events published by the ingestion system so whenever there is a new content ingested, recognition system 110 may retrigger its process to update database 108, such as using information of a performer list.

At 304, recognition system 110 performs an image search using the object name. In some embodiments, a search may be performed using the object name as a keyword. The search may be of any database (e.g., internal, external, the Internet), network (intranet, external network), or other source of information. In some embodiments, recognition system 110 performs a search of the Internet using the object name as a keyword. Performing the search with the object name may make it likely that the results may be highly relevant with the target object. For example, it is expected that the images that are returned in the search for the object name may most likely include the object. However, these images may also include other objects, such as other performers that are in the image or just another object.

At 306, recognition system 110 receives the image results. The image results may be a series of images. Recognition system 110 may use a portion of the image results, such as ten of the image results, or any other number.

At 308, recognition system 110 performs object detection on the image results to determine object samples in an object collection. The object detection may detect the existence of objects in the image, such as a facial detection algorithm may be used to detect the faces in an image. After detecting the face, data is extracted, such as the face and other information, such as the body of the person. In some embodiments, each object sample may be an image of one object. As discussed above, since the search with the object name is used, the majority of the object samples in the object collection may belong to a type of object, such as the target object.

At 310, recognition system 110 performs object clustering to generate object clusters. The clusters form groups of object samples that may be considered similar. In some embodiments, a distance threshold is used to determine which objects should be included in which clusters. The clustering process may use the distance threshold to assign objects to a cluster. The goal of clustering is to identify groups of objects that are more similar to each other than to objects in other groups. To achieve this, the clustering algorithm uses the distance threshold to measure the similarity between objects. Objects that are within the distance threshold may be clustered together in a cluster. For example, if there are nine objects detected in the images, two to five clusters may be determined. The cluster with the most object samples in it may be expected to be the one that includes the target object. This is because the search with the object name may return more images of the target object than images of other objects.

At 312, recognition system 110 selects a cluster. The cluster that may be selected is the cluster that has the most objects in it. This continues with the logic that the search with the object name yield more objects that are the target objects than other objects.

At 314, recognition system 110 updates database 108 with representations of objects in the selected cluster. For example, each object in the selected cluster may be encoded into a representation, and indexed with the object name.

### Clustering

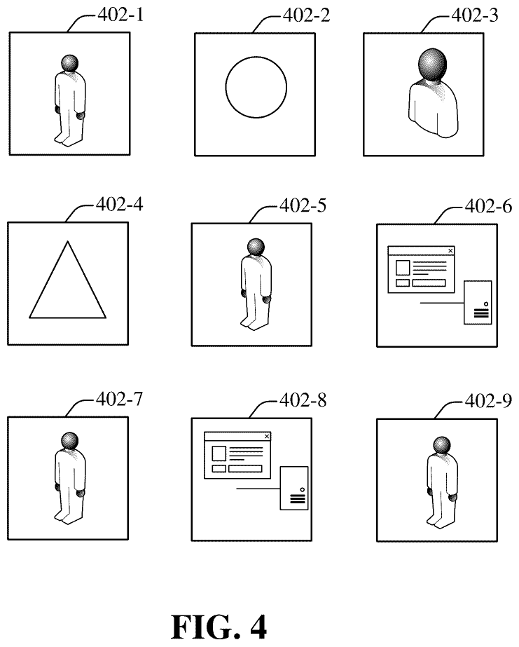

FIGS. 4 to 7 depict an example of performing clustering according to some embodiments. The clustering may experience challenges when attempting to cluster objects. For example, objects other than the target object might impact the clustering accuracy. Also, it may be hard to determine the distance threshold that is used to determine the clusters. The following describes how the challenges are addressed using a pre-processing step that improves the clustering accuracy and speed of clustering.

FIG. 4 depicts an example of object samples according to some embodiments. The object samples may be recognized from the search results. In some examples, some images in the search results may include multiple objects. This results in more objects being detected than the number of search results. For example, six images may be received in the search results, but nine object samples are detected. Object samples 402-1 to 402-9 (collectively object samples 402) may be images of objects that are detected in the search results. Object samples 402 may depict different objects. In some embodiments, the target object is depicted in object samples 402-1, 402-5, 402-7, and 402-9.

Other object samples may depict other objects. For example, object sample 402-3 includes a different person from the target object. Object samples 402-6 and 402-8 depict a type of computer. Object sample 402-2 depicts a circle and object sample 402-4 depicts a triangle.

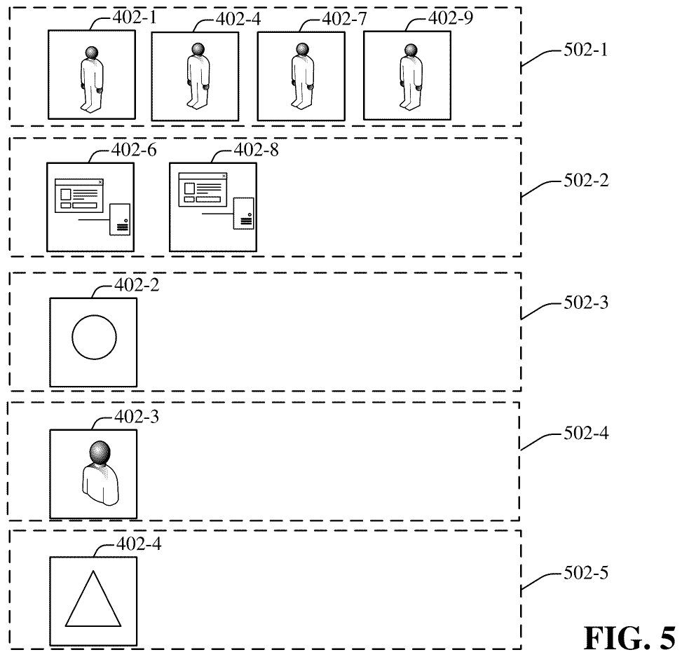

FIG. 5 depicts an example of clustering of the object samples 402 if pre-processing is not performed according to some embodiments. In this example, the clustering algorithm generates five clusters 502-1 to 502-5. Although these clusters are shown, other numbers of clusters may be appreciated.

Cluster 502-1 includes the most objects. This cluster may be the cluster that is expected to include the target object. Cluster 502-2 includes the two computers 402-6 and 402-8. Clusters 502-3 to 502-5 include the circle 402-2, other person 402-3, and triangle 402-4, respectively.

The existence of other objects may affect the clustering. For example, although not shown, the other person 402-3 may be included in cluster 502-1. If the other person is then included in database 108 and associated with the target object name, this might return wrong results in the processing stage. The following pre-processing may improve the clustering process.

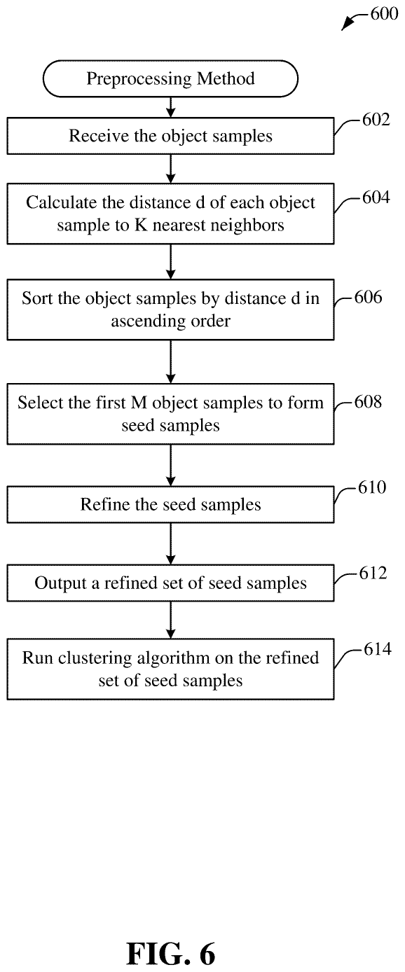

FIG. 6 depicts a simplified flowchart 600 of a method for performing pre-processing according to some embodiments. The pre-processing is based on the assumption that the objects of the target object should occupy the majority part of all of the objects in the images. In other words, the number of object samples that belong to the target object should be more than the other individual object samples. This assumption may be true because the search is performed with the object name, which should return more images of the target object than other objects.

At 602, recognition system 110 receives the object samples. The object samples have been detected from the search results.

At 604, recognition system 110 calculates a distance d of each object sample to K nearest neighbors. The distance d may be an average distance, but other distances may be used, such as a median distance.

At 606, recognition system 110 sorts the object samples by distance d in an order, such as an ascending order. This may sort the object samples from the smallest distance to the largest distance. The value of K nearest neighbors may be a value that is less than the number of images returned in the search results. The value of K nearest neighbors may also be larger than the number of any other individuals. For example, the value of K may be six in the above example because there were six images in the search results. Recognition system 110 may want to select the six target objects that were included in the six search results. If the search with the name as the keyword yields relevant results, most of the search results should contain the target object. If there are 10 results, most of them should have the target object in it. But there might be other objects, but the number of their appearance should be less than the number of target objects because it is not likely that every single image that has the target object in it also has the same other objects as well.

At 608, recognition system 110 selects the first M object samples to form seed samples. The seed samples may be regarded as the most confident samples that may belong to the target object. The value of M may be the value of the desired number of seed samples. (M is a hyper parameter which can be set by heuristic way, for example, 0.8 times number of total images. The following may be used to determine the M seed samples D:

d̅₁<d̅₂<. . . <d̅_{M}<. . . <d̅_{N}

D={d̅ᵢ}, i=1, . . . M

The average distance d̅ᵢ is for K nearest neighbors to a seed sample i, and the set D is the first M seed samples.

At 610, an optional step of refining the seed samples may be determined. For example, recognition system 110 may remove the farthest samples from the center of the seed samples to reduce the impact of non-target objects. Also, the clustering distance threshold may be calculated according to distances D. For example, the distance threshold t may be calculated as the following:

t=max (D)=d̅_{M}

The above may calculate the threshold as the maximum of the distances in the set D of seed samples. The threshold is used to determine which samples belong to a same cluster. Two samples with distance smaller than the threshold are regarded as in the same cluster, otherwise, they are not. For example, 10 images are received by searching “Object Name 1”, and there are 10 Object Name 1 and 5 Object Name 2 and 4 Object Name 3 in them. The threshold is determined such that a number of objects that are smaller than the number of samples, but larger than the number of other objects. If K is set to 10 and M is to 8, if d̅_{M} is the threshold, the threshold can make sure most of the Object Name 1 samples can be clustered together since the 8^{th} K-nearest average distance is likely from an Object Name 1 sample and the distance between most of the Object Name 1 samples is smaller than this value. Although this formula is described, other calculations may be used.

At 612, recognition system 110 outputs a refined set of seed samples. The refined set may have one or more object samples that have been removed. If the seed samples have not been refined, then the original seed samples are output.

At 614, recognition system 110 runs the clustering algorithm on the refined set of seed samples (or the original set). After running the clustering, recognition system 110 may select one of the clusters, such as the cluster with the largest number of objects, to update the database 108 with representations from the objects in the cluster.

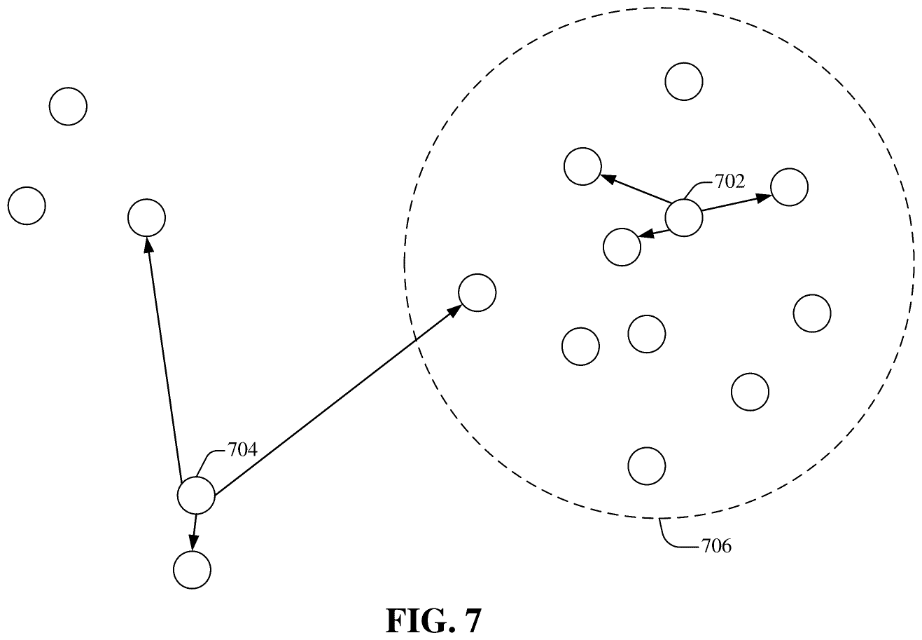

FIG. 7 depicts an example of selecting seed samples according to some embodiments. Different objects are shown in a space. The objects may be the representations of the objects.

Depending on the value of the representation, the representation may be shown in different areas of the space. If the value of K is the three nearest neighbors, the average distance d for each object sample may be calculated. The value of K may be set at the number of images that are returned in the search results.

At 702, an object sample has a distance d calculated using distances from the shown three objects that are nearest the respective object. For example, the object sample has a distance d calculated with the three objects connected by arrows that are nearest the respective object.

At 704, the distance d for another object sample is calculated using the three objects connected by arrows that are nearest the respective object. As can be seen, this average distance for the object at 704 is larger than the average distance for the object at 702. Accordingly, the average distance for object samples in the cluster at 706 may be less than object samples outside of the cluster. This is because a cluster with the most object samples may be able to find three samples that are closer together than objects that are outside of the cluster. Then, the results in the cluster 706 may be target objects from one of the images that is returned in the search results. The other object samples may be from other objects that may have been found in the search results.

### Conclusion

Accordingly, database 108 may be updated automatically with representations for new objects. Database 108 is improved by saving storage space by accurately storing objects for a target name. Also, the process may scale automatically using less resources than training of a large language model. For example, database 108 may be updated faster than retraining of the large language model using the clustering process. The storing of representations in database 108 may be improved using pre-processing. This may improve the speed of which the clustering can be performed. The response time for responding to queries after updating database 108 may also be improved. For example, determining the representation that is closest to the input representation may be faster than using a large language model that analyzes the input image and a text query asking what are the object names in the image. This is because the search of the database of representations may be faster than the processing of the query for the large language model.

### System

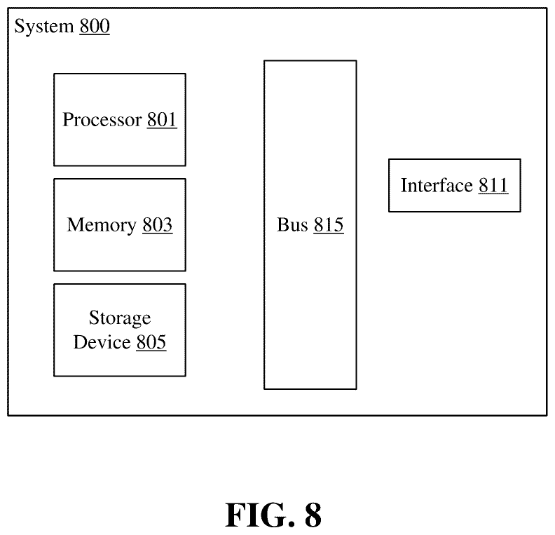

FIG. 8 illustrates one example of a computing device according to some embodiments. According to various embodiments, a system 800 suitable for implementing embodiments described herein includes a processor 801, a memory 803, a storage device 805, an interface 811, and a bus 815 (e.g., a PCI bus or other interconnection fabric.) System 800 may operate as a variety of devices such as server 104, or any other device or service described herein. Although a particular configuration is described, a variety of alternative configurations are possible. Processor 801 may perform operations such as those described herein. Instructions for performing such operations may be embodied in memory 803, on one or more non-transitory computer readable media, or on some other storage device. Various specially configured devices can also be used in place of or in addition to processor 801. Memory 803 may be random access memory (RAM) or other dynamic storage devices. Storage device 805 may include a non-transitory computer-readable storage medium holding information, instructions, or some combination thereof, for example instructions that when executed by the processor 801, cause processor 801 to be configured or operable to perform one or more operations of a method as described herein. Bus 815 or other communication components may support communication of information within system 800. The interface 811 may be connected to bus 815 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving a plurality of images based on a search using a name for a first object;
performing object detection to determine a collection of objects;
performing object clustering on the collection of objects to generate a plurality of object clusters;
selecting a cluster in the plurality of object clusters, wherein the cluster includes one or more versions of the first object;
encoding the one or more versions of the first object into one or more representations; and
storing the one or more representations in a database to update the database, wherein the database is used to recognize the first object in an input image.

2. The method of claim 1, wherein:
the first object is associated with a person, and
the name is a name of the person.

3. The method of claim 1, wherein images in the plurality of images include the first object and one or more second objects.

4. The method of claim 1, further comprising:
performing the search using a search engine with the name as a keyword of the search.

5. The method of claim 1, wherein performing object detection comprises:
detecting objects in the plurality of images to determine individual images of objects in the collection of objects.

6. The method of claim 1, wherein performing object clustering comprises:
clustering objects that meet a condition together in a respective cluster.

7. The method of claim 6, wherein:
a type of object is clustered into a respective cluster.

8. The method of claim 6, wherein:
the condition is a distance threshold, and
objects within the distance threshold are clustered in a cluster.

9. The method of claim 1, wherein performing object clustering comprises:
calculating a distance measurement for K neighbors of each object in the collection of objects; and
selecting the cluster using the distance measurement.

10. The method of claim 9, wherein selecting the cluster using the distance measurement comprises:
sorting the objects in the collection of objects by a respective distance for each object in an order; and
selecting M objects from the order as the collection of objects.

11. The method of claim 10, further comprising:
removing N objects the M objects with a largest respective distance from the order before selecting the cluster.

12. The method of claim 10, further comprising:
calculating a value of a distance threshold based on respective distances in the M objects, wherein the value of the distance threshold is used to select the cluster.

13. The method of claim 12, wherein:
the distance threshold is calculated as a maximum of a number of distances for the M objects.

14. The method of claim 9, wherein K neighbors is a value of a number of the plurality of images.

15. The method of claim 1, wherein:
the representations that are stored in the database are associated with the name of the first object.

16. The method of claim 1, further comprising:
receiving an input image;
encoding the input image to generate an input representation;
retrieving a representation from the database that is determined to match the input image; and
outputting the name that is associated with the representation.

17. The method of claim 16, wherein the representation from the database that is determined has a closest distance to the input representation.

18. A non-transitory computer-readable storage medium having stored thereon computer executable instructions, which when executed by a computing device, cause the computing device to be operable for:
receiving a plurality of images based on a search using a name for a first object;
performing object detection to determine a collection of objects;
performing object clustering on the collection of objects to generate a plurality of object clusters;
selecting a cluster in the plurality of object clusters, wherein the cluster includes one or more versions of the first object;
encoding the one or more versions of the first object into one or more representations; and
storing the one or more representations in a database to update the database, wherein the database is used to recognize the first object in an input image.

19. The non-transitory computer-readable storage medium of claim 18, wherein:
the first object is associated with a person, and
the name is a name of the person.

20. An apparatus comprising:
one or more computer processors; and
a computer-readable storage medium comprising instructions for controlling the one or more computer processors to be operable for:
receiving a plurality of images based on a search using a name for a first object;
performing object detection to determine a collection of objects;
performing object clustering on the collection of objects to generate a plurality of object clusters;
selecting a cluster in the plurality of object clusters, wherein the cluster includes one or more versions of the first object;
encoding the one or more versions of the first object into one or more representations; and
storing the one or more representations in a database to update the database, wherein the database is used to recognize the first object in an input image.
